(19) United States
(12) Patent Application Publication
(10) Pub. No.: US 2005/0114183 A1
(43) Pub. Date: May 26, 2005

(54) Advertising method and system for health related fields

(76) Inventors: Leonard D. DiGiovanna, West Hempstead, NY (US); Philip D. Ragno, Mineola, NY (US)

Correspondence Address: NATH & ASSOCIATES PLLC;Sixth Floor, 1030 Fifteenth Street, N.W., Washington, DC, 20005, US

(21) Appl. No.: 10/938,549

(22) Filed: Sep. 13, 2004

Related U.S. Application Data
(60) Provisional application No. 60/501,859, filed on Sep. 11, 2003.
(60) Provisional application No. 60/516,318, filed on Nov. 3, 2003.

(51) Int. Cl. G06F 17/60

(52) U.S. Cl. 705/2

(57) ABSTRACT

A permissible advertising method and system for the health care field is disclosed in which promotional information about a medical company is provided to patients and anyone accessing information about the patient. The system includes a portable storage device such as a pen drive that is kept by the patient and that is connectable to a universal port of a computer. Medical records and information about only that patient are stored on the pen drive in a plurality of self-executing files. Also stored on the pen drive is promotional information about the medical company and an application computer program that will provide the promotional information along with a file when the file is opened and displayed by the computer on either or both a monitor and a document printed by a printer. Alternatively, the promotional information and/or the application computer program can be kept on the accessing computer. Advertising indicia or logos of the medical company can be located on the pen drive.

### FIELD OF THE INVENTION

The present invention relates in general to a method and apparatus for advertising in the health related fields. More particularly, the present invention relates to the use of conventional personal computers in the health care field to promote the products of medical suppliers.

### BACKGROUND OF THE INVENTION

Today's health system product market is generally divided into two branches, prescription required and no prescription required, or Over-The-Counter (OTC), and each branch has two divisions, pharmaceuticals and medical devices. Medical devices in the OTC market would include splints, bandages, etc., and in the prescription market would include heart valves, heart pacemakers, skin grafts, and diagnostic computer software.

The channels of trade and methods of promotion in the health related fields or health care systems, called generically herein as simply health systems, has been quite traditional and somewhat rigid. Health systems include: Pharmacies; health insurance agencies; patient management; health related government agencies; attorneys working on health care issues; health care proxies (persons appointed under a living will); hospitals; medical and dental clinics; physicians offices; chiropractors; dentists; holistic clinics; pharmaceutical companies; medical device manufacturing companies; and radiology and laboratory clinics.

The users of Medical products, the patients, usually have little knowledge of the products that they are receiving, their manufacturers, or even the trademarks under which they are sold. Those having that knowledge are the health care providers. Consequently those benefitting from health care products are unable to participate in their selection. On the other hand, the medical companies would love to be able to entice patients to request their products. Not only that, they would love to be able to continue to keep the patient's interest in their medical products.

Generally the lack of knowledge of medical products by the using patients and the inability of the medical companies to provide that information is the result of the market environment in which such products travel. In particular, it seems that the rigidity and difficulties in the promotion of pharmaceutical products and medical and dental devices (sometimes called herein for convenience “medical products”) is due to the extremely tight regulation and custom that encompasses the field. This perhaps begins with the Food and Drug Administration (FDA) with its very exacting requirements for the content and method of delivery of advertisements. For example, it is only recently that the FDA has permitted pharmaceutical drug companies to advertise prescription drugs on television. But it also includes ethical regulations imposed both by state laws and to a lesser extent the American Medical Association and other medical associations. In the past this has resulted in, for example, the pharmaceutical and medical apparatus companies, the companies that manufacture and distribute medical products (sometimes called herein for convenience “medical companies”), having to market their products not to the users, but rather to the medical and health care providers. Most unfortunately, this has had numerous deleterious effects because it has necessitated employing a legion of representatives and having them pay personal calls on busy, practicing prescribing doctors, dentists, and other health care providers. This is obviously a huge cost to the companies to field a large number of persons to cover the country, and a large expenditure of time of the health care providers to listen to these people. It has also created an under field of activity and expenditure just to get the health care providers to listen to the company representatives. This activity includes lavish affairs at medical, dental, and other health care providers conventions, the giving of expensive gifts, and the provision of expensive educational seminars at resorts and even on ocean. cruises.

With the relaxation somewhat by the FDA to permit television advertisements of drugs, the general public who are the users of the drugs are beginning to learn about the specific products which they need. They usually learn the easier to remember trademarks of those drugs, and not so surprisingly, are beginning to ask specifically for those drugs by their trademarks when they visit their health care providers. This form of promotion has worked extremely well for the pharmaceutical companies because now they have achieved a direct line of communication to the patients and can rely less on the traditional methods of promotion.

Obviously there is still a need for additional promotional vehicles so that the walls that has been built between the medical companies and the consumer can be overcome. However, any new promotional activity must still be within the existing guidelines and controls.

There are many effects of the restrictive ways in which medical companies can promote their products. These include the inability to obtain name recognition, to engage the appropriate target audience, and to demonstrate the superiority of their products. In the increasing competitive medical market, the medical companies are striving to overcome these effects, and for some, such as the medical device companies, it appears that they are not succeeding.

Important potential marketing strategies of a medical company is to forge a partnership with the patient by providing effective therapies and educational materials and to satisfy the growing desire to make medical records accessible to patients, insurers, physicians and hospitals.

At the same time, there is a need for patients to have ready access in a secured way to their medical records and medically related information. Too many medical files are lost or cannot be retrieved in a real time situation. Patients keeping all of their medical information and records and bringing for example their medication lists, medical records, xray and CAT scan films, ekg records, and the like with them every time they visit a new physician or diagnostic facility is no answer either. This is something to be avoided because the patients do not have a secure and climate controlled facility to keep them, do not have the ability to lose some of the papers or films, and usually would not bring all of their records with them in any case. There is also the problem of a traveling patient. These people cannot usually carry such records along with them at least because of their sheer weight and bulk and the security issues involved. Yet a traveling patient needs to supply the appropriate medical records when away from home in order to avoid inappropriate or unnecessary treatment

However, the provision of a distributed data bank of such records and information has security and privacy concerns, cost concerns, and concerns about the effectiveness of a distribution to the patient. While some have suggested the Internet as a possible solution, the current presence of hackers, privacy concerns and data reliability, it appears that this solution could be years away. As just one example of an internet based advertising system see the business method patent application publication US 2002/0116263 published Aug. 22, 2002, incorporated herein by reference. Furthermore, the standardization of an Internet based system so that health care providers can have access to the records and information requires a huge expenditure of research, time and money with little possibility of return to the creators, that there is little incentive for entrepreneurs. Perhaps the lure of the “dot com” community in-the late 1990's might have provided the necessary incentives, with the return being in the form of advertising, that lure does not exist today in the early 2000's after the collapse of that community.

### SUMMARY OF THE INVENTION

The present invention satisfies the thus established need by medical companies for an easy, affordable mechanism for providing permissible advertising and promotional material from health care companies to the ultimate user, the patient. At the same time the present invention satisfies the need by patients for an easy, affordable and readily available source of their crucial medical information when it is needed by caregivers. The present invention provides an affordable, distributable mechanism that eliminates waiting for medical staff members to locate, obtain authorization, copy and fax, transmit by email, or mail materials. Also, the present invention eliminates the possibility of misfiling or misplacing medical records. It also satisfies the need in today's increasingly volatile global environment by a traveling patient to be able to take comfort in knowing that their medical records are always at their disposal.

The present invention has numerous benefits, including making patients medical records readily available, protecting the confidentiality of these records, alleviating the fear of the “big brother who is watching you,” and making medical records secure.

The present invention facilitates treatment while avoiding the need to request or wait for a new physician or institution to obtain records. It provides potentially life saving records 24 hours a day, 7 days a week. The present invention avoids the constant or redundant need to supply medical history, medication and problem lists and list of treating physicians. It avoids a patient bringing treated or admitted for an “abnormal test” when that abnormality may have already been diagnosed, evaluated and treated, an example being an abnormal EKG. With the present invention, the complete medical records and information is never part of the public domain, and in fact never leave the side of the patient or their families. Security can easily be provided with a simple password. And best of all, the present invention can be achieved with minimal or no expense to the patient. The cost can be borne willingly by the medical companies because the present invention also fulfills the objectives for the medical companies. The present invention does all of the aforementioned completely within the requirements and dictates of law and the health system.

Features and advantages of the present invention is that it can store and handle dozens of images, reports and files, is accessible on all Microsoft Windows operating systems, saves images files in a self-opening or self-executing format so that they can be opened simply by clicking on their icon, a self-opening viewer circumventing the need for any special viewer (while displaying changing advertising and promotional banners), and a conventional scanner that is user-friendly, compact, USB compatible for quickly scanning records in less than 15 seconds per page. The present invention incorporates conventional hardware and software together with special software to create a seamless blend into one user-friendly system that allows users to quickly scan and save data directly onto a portable memory device such as a pen drive.

The present invention is comprised of three basic components: a conventional computer hardware system, a highly portable, completely independent, and easily and readily removable data storage device, and a computer program to permit the storing of information into the storage device, the reading of the data from the storage device, and the display of appropriate promotional and informational messages.

The present invention integrates a retrieved file with a stored commercial message from the sponsoring medical company. The commercial message can be or include the logo of the sponsoring medical company, an advertising message, a promotional message, and a message containing helpful information about a medical product. The commercial message often includes the sponsoring medical company's name and logo. When an executable medical image file is initialized the logo of the medical company automatically opens and pops up exposing the user to the company or product, as well as providing a direct hyperlink to a predesignated website or websites. The user can then print the selected image file together with the logo of the company.

The present invention has the following impact on the clinician. Patients can now present to their health care provider their own personal portable storage device. The health care provider can charge the patient for an office visit or consultation to load the patient's important medical records including medication and problem list into the portable storage device. The patient now has an updated, complete record of his or her medical records. This procedure will reduce the physicians out of pocket costs for sending medical records by facsimile, photocopying, and/or mailing expenses. Also, by keeping patients interested in their medical care, the patient's compliance with their treatment is improved.

The present invention has the following impact on the medical manufacturer. The manufacturer will gain name recognition with the user of the medical manufacturer's product, the patient. Patients will become aware of and familiar with the products of the medical manufacturer, and when they need those products, they will request them by name from their physicians. The device medical manufacturer can team with a pharmaceutical medical manufacturer so as to benefit from the latter's field marketing personnel as follow-up to provide information to the physicians.

In one proposed embodiment of the present invention, a physician is given a scanner, a USB hub, and the application software at no cost. This expense is not large when the other promotional expenses of a medical company are considered. Local representatives or the medical companies deliver and install the application software and drivers free of charge. Alternatively, for those physicians who have an Information Technology (IT) manager, the software and drivers can be sent to them by courier or downloaded from the website of the medical company.

The delivery and payment of a storage device according to the present invention to the patient can be done by one or more of a number of ways. The medical company could pay for the cost of the storage device and give it to the patient via the physicians for free. The patient could pay some or all of the cost with any balance being subsidized by the medical company. The patient could be given a certificate that would entitle the patient to a rebate for some or all of the cost to the medical manufacturer when one of its products has been ordered by the physician for that patient. The physician could purchase the storage device and distribute them to the patient for free or a fee. The cost to the physician could be paid by the physician, or rebated by the medical company. Also, the storage device could be purchased by the patient at pharmacies or over a web site and the patient bear all or some of the cost, and the medical company rebate some or all of the cost.

In a more specific embodiment of the present invention, the software driven computer hardware system is located at health system facility and includes a conventional personal computer, a plug receivable interface, a monitor, and a scanner; while the storage device is kept by the patient. In a still more specific embodiment, the storage device can be a USB or firewire compatible pen drive, sometimes called a memory stick or flashcard. Preferably the storage device is a self contained electronic storage device that draws its power from a computer to which it is connected and the software storing the files on the storage device installs self executing files so that when simply addressed by, for example, an IBM or compatible computer running a Microsoft Windows, the files will open up and display their contents on a monitor.

These and other advantages, objectives, and features of the present invention are mentioned in or are obvious to one of ordinary skill in the art.

### BRIEF DESCRIPTION OF THE DRAWINGS

FIG. 1 is a schematic diagram illustrating a hardware computer system according to the present invention;

FIGS. 2-1 and 2-2 are together a flow chart depicting the creation of a self-executing file of a medical record, such as an EKG chart;

FIGS. 3-1 and 3-1 are together a flow chart depicting the use of the present invention presenting advertising material.

FIG. 4 is a flow chart depicting one method of storing and updating an advertising banner on a patient's portable storage device or the host computer and for display with a patient file.

### DETAILED DESCRIPTION OF THE PREFERRED EMBODIMENTS

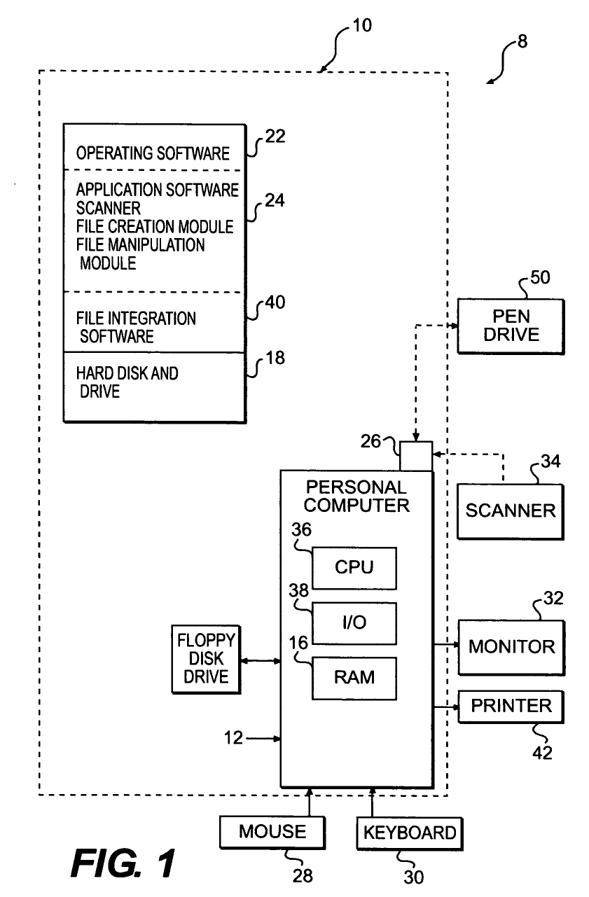

With reference now to the figures wherein like elements have the same number throughout the several views, and in particular with reference to FIG. 1, a conventional computer system 8 is comprised of: a computer housing 10 containing a personal digital computer 12; an internal temporary memory 14 such as Random Access Memory 16 and internal permanent read-write memory, such as a hard disk drive which contains a hard disk (not shown) denoted 18 and a floppy disk drive 20 which receives removable floppy disks (not shown), operably connected to computer 12; an operating system software such as a Microsoft Corporation Windows 98 or higher generation computer program stored on hard disk 18 and generally indicated at 22; application software stored on hard disk 18 such as scanner software, a file creation module, a file manipulation module to retrieve, print, read, modify, copy and move files, and generally indicated at 24; and an input/output USB port 26. Port 26 is shown as a multiple connection port, but it could also be replaced by a single USB port on the computer and an expansion port device. In addition, port 26 could be a firewire port. Computer 12 is connected to input devices and output devices such as: a mouse 28; a keyboard 30; and a monitor 32. Computer 12 is also connectable through USB port 26 to a scanner 34. However, scanner 34 could also be usually connected to computer 12.

Digital computer 12 is comprised of a number of conventional parts such as a mother board or system board (not shown) on which is mounted RAM 16, a CPU 36, such as an Intel Pentium 5, and input/output circuitry 38.

Also stored on hard disk 18 is file integration software in accordance with the present invention and generally indicated at 40.

Although a principal output device is monitor 32, other output devices connected to computer 12 would include a conventional printer 42 and a facsimile machine (not shown).

Connectable to port 26 is a conventional removable pen drive 50. Pen drive 50 is a relatively new, now conventional, device that can be password protected and can store up to a half of gigabyte of data. It is sometimes also called a flash card or memory-stick. It is a storage medium that contains circuitry, and an active element storage component, and thus is electronic. It draws its power from the device to which it is connected, but the data is permanently stored. A pen drive is thus an active element storage device that can be contrasted to a passive element storage device such as a magnetic storage device that includes a conventional floppy disk, a magnetic tape, or a hard disk, and an optical storage device such as a CD ROM.

However, a storage device as used herein includes both an active storage device and a passive storage device. The primary features of such a storage device include portability, connectability to a computer system, read and write capable, and small enough such that a patient or health care user can easily take it with them and carry it, such as in a purse or clothing pockets, and would want to carry the storage device. The key is A pen drive is small enough and of such an external configuration that it could even be connected to a chain and carried around the neck of the user. Also included in this definition would be any device that is portable and can retrievable store data. In the health care field a portable storage device would even include an implanted heart pacemaker, which device can be nonintrusively read and written to with a reading wand.

Distribution of pen drives 50 to patients, and the payment therefor, has been discussed above, but will be further described here.

Physicians would be encouraged to pay for part or all of the system because they could charge for an office visit when they explain the results of medical procedures to their patients and upload the information to pen drives 50.

Patients who are computer knowledgeable can upload their own information from Internet websites maintained by their physicians or by a Medical Company. The concurrent display of advertising and promotional material on the website to website visiting patient accomplishes the advertising aspects of the present invention, as does the appearance of such material stored on the patient's personal pen drive 50. Material loaded on the pen drives will also repeatedly steer the patient to the website of the Medical Company. Also, every visit to the website of the Medical Company can be used as an opportunity to download additional or replacement advertising and promotional material, including new banners and pop-up displays.

It is also contemplated that website visits can be used to register the patient and the patient's pen drive 50. Such registration can also occur upon purchase of pen drive 50.

Pen drives 50 can also ;be sold over the Internet at appropriate websites, such as those owned by book sellers; by drug stores that advertise; and by insurance companies. Obviously, such direct sales to the patient could also be made in drug stores, book stores, etc.

A Medical Company can offer pen drives 50 to insurance companies and they in turn can supply them to their insured with or without the insurance information of the insured preloaded. Payment for pen drive 50 and the associated software can be shared by the Medical Companies, the insurance companies and the insured, or,absorbed by one or two of them. The incentive for insurers to distribute pen drives 50 to insured is that the insured will always have test dat on hand and redundant testing and lab work (e.g. blood work and ekg's) can be drastically reduced. Also, insurance companies have the economic power to require that hospitals, physicians, pharmacies, and labs have the requisite computer system 8, and can even require or encourage that their insureds carry a personal pen drive 50. Also, it is possible that the costs for pen drives 50 and perhaps even computer system 8, can be offset by Medicare or governmental grants under the theory that using pen drives 50 will ultimately save money and perhaps even lives.

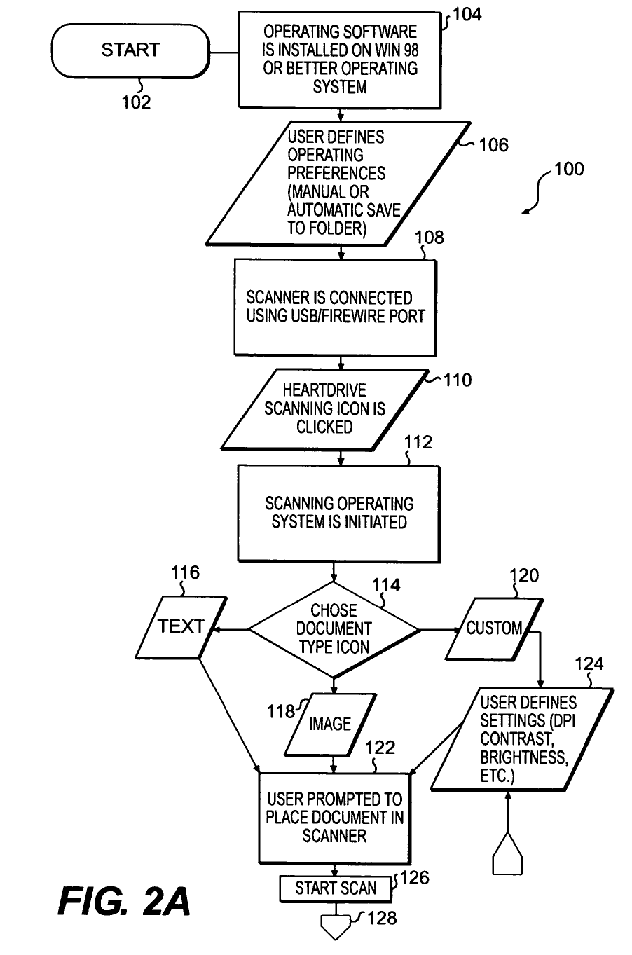

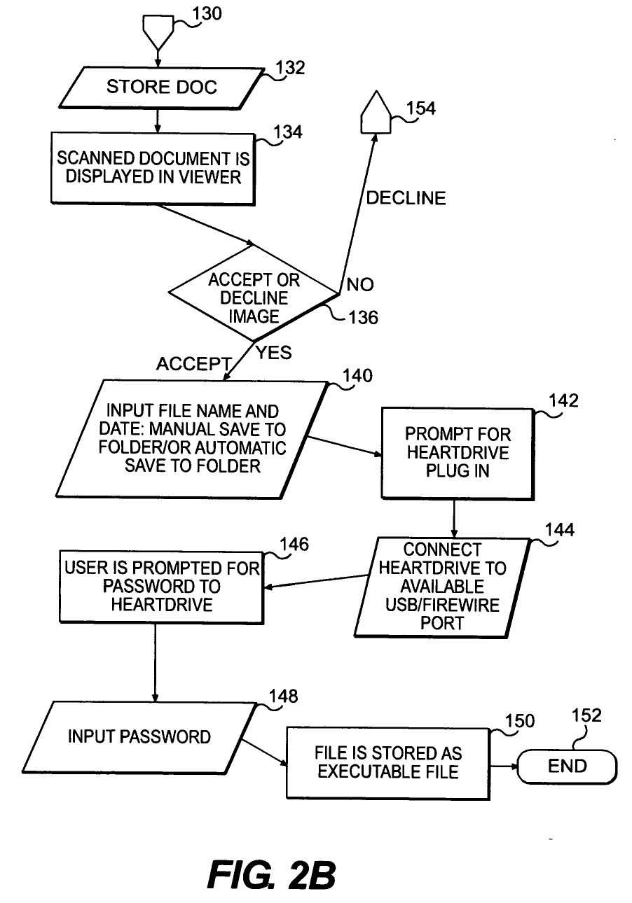

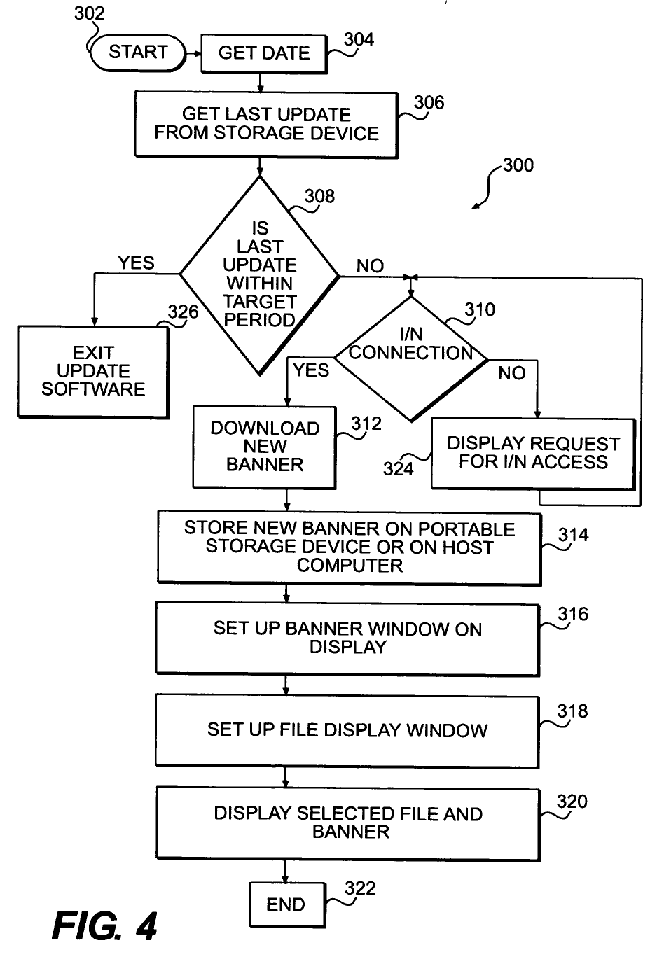

With reference now to FIGS. 2-1 and 2-2, a flow chart 100 depicts an exemplary and presently preferred procedure or process for installing a patient data base on pen drive 50, or some other memory device according to the present,invention. The process starts for a particular joining physician at start symbol 102 which proceeds to process element 104 in which an application program according to the present invention and described herein below with respect to FIG. 4 for one embodiment thereof. The process continues to an input element 106 where the user defines the operating preferences of manual or automatic save to a program designated folder. In process element 108, if not already connected, scanner 34 is connected to a host computer 12, which is usually the computer of the health care provider, preferably using USB port 26. An icon on the desktop of computer 12 representing the storage device (called herein by its trademarked name “HeartDrive,” is clicked in input element 110 and the scanning operating system is initiated, as indicated in process element 112. A document icon is then selected in decision element 114 by the operator as either a text file icon 116, an image file icon 118, or a custom image 120. If the text icon 116 or an image icon 118 is selected, then the process proceeds to process element 122 where the user is prompted to place a document in the scanner. If the custom icon 120 is selected, then the process proceeds to input element 124 where the user defines the setting (dpi contrast, brightness, etc.) and then the process proceeds to process element 122. Once the document is in the scanner, the process continues to an input element 126 in which the scan is initiated. The scanner application software is conventional, often being bundled with the scanner hardware and the two sold together. The process proceeds to FIG. 2-2, as indicated by an off-page connector 128 in FIG. 2-1 and an off-page connector 130 in FIG. 2-2.

With reference to FIG. 2-2, the process proceeds to process element 132 where the scanned document is temporarily stored in computer RAM memory 16 as a bit map and then to display element 124 where the scanned document is displayed on monitor 32. From display element 124 the process proceeds to a decision element 126 where the operator makes a decision either to accept or reject the scanned document. If the scanned document is accepted, the process proceeds to input element 140 where the user inputs a file name and date.

It is at this point that either the scanner application software or third party software is used to save the scanned bit map as an executable file. An executable file is a conventional term that means all a user has to do to display a file is to use the Windows operating system software to display the icons of the file and then click on the icon. The executable file has a computer program stored within it which opens and displays the file without the necessity to use another program, such as Word Perfect or MS Word. This also has the advantage that the display of the file is not dependent on the computer system that created the file or the computer system that displays the file. Conventional software is available to do this function, such as one currently being sold under the mark “Paper Port Mini Viewer.” Returning to process element 140, the user choices to manually save the inputted document to a selected folder, or the program automatically saves the program to the current folder. Next, in process element 142, the computer displays a prompt on monitor 32 to plug in pen drive 50. The process proceeds to input element 144 where the user plugs in pen drive 50 into USB port 26 and the user is prompted on monitor 32 to supply a password in process element 146. The user inputs the password in input element 148 and the process proceeds to process box 150, after which the program terminates as indicated in connector 152.

If the scanned document is rejected in decision element 136, the process returns to FIG. 2-1 via an off-page connector 154.

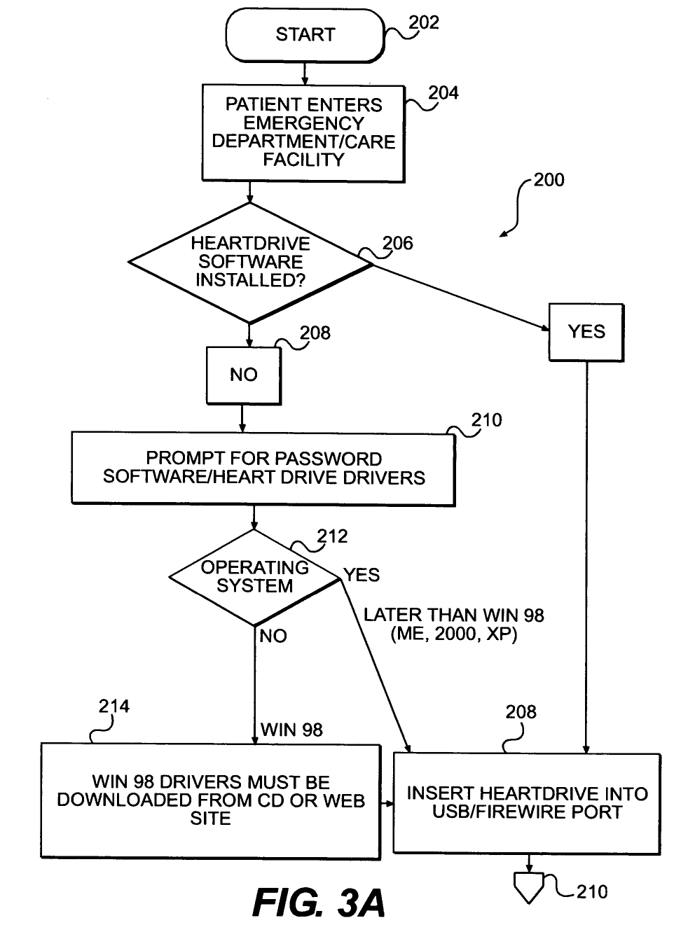

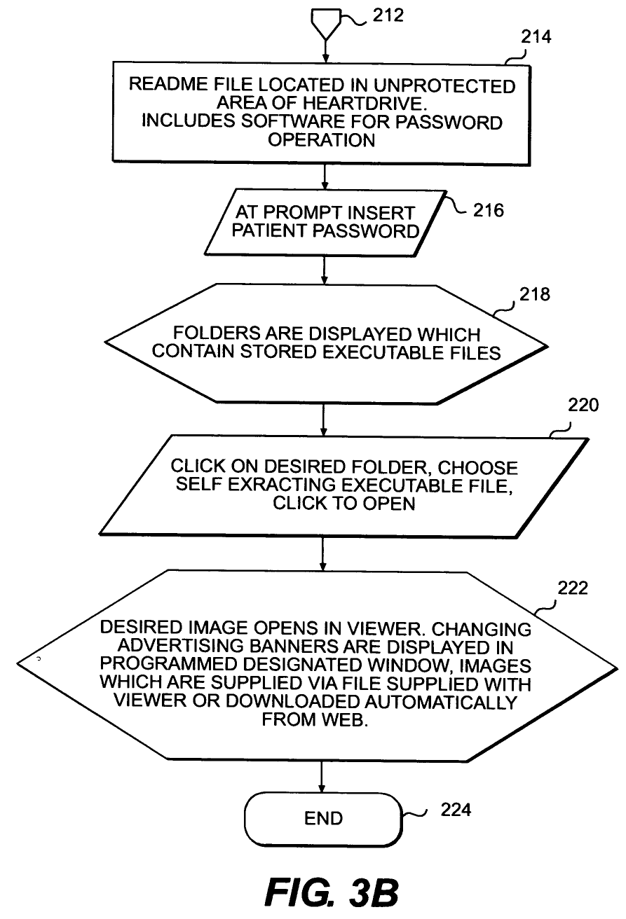

In FIGS. 3-1 and 3-2, a process 200 depicting a typical scenario of a patient using the present invention. From start element 202, the process proceeds to a patient entering for example an emergency department or a care facility. In decision element 206, the system software according to the present invention asks if the heartdrive software is installed. If it is installed, the process proceeds to input element 208 where the user is prompted to and does insert the HeartDrive into USB port 26. If the software is not installed, the process proceeds to process element 210 where computer 12 prompts the user on monitor 32 for a password and once given the process proceeds to a decision element 212 where the operating system software 22 is determined. Because the Windows operating systems Windows 98 does not contain appropriate drivers, a different procedure is required, as indicated in process element 214 where the WIN 98 drivers are downloaded. In either case, the process proceeds to input element 208 where the user inserts pen drive 50 into port 26. The process proceeds to FIG. 3-2 as indicated by off-page connectors 210 and 212.

From off-page connector 212, the process proceeds in FIG. 3-2 to a process element 214 where the readme file, previously stored in an unprotected area of pen drive 50, is located. The process then goes to input element 216 where the user is prompted to input the patient password which has been previously stored in pen drive 50. Upon the determination of an acceptable password having been inputted, the process proceeds to a subroutine 218 where the folders which contain the stored executable files, previously loaded onto pen drive 50, are stored, and displays the folders. The process proceeds next to input element 220 where the user after having been prompted to do so, clicks (i.e. selects) the icon for the desired self-extracting executable file. In subroutine element 222, the desired image opens in a predesignated widow and is displayed on monitor 32. Changing advertising banners are displayed in a programmed designated window (not shown) on monitor 32. The process terminates at terminal element 224.

With respect to FIG. 4, the flow chart of a software application program is depicted at 300 which is automatically implemented at subroutine element 222 in FIG. 3-2 or process element 146 in FIG. 2-2. The program is opened and starts in element 302 and proceeds to process element 304 where the program gets today's date and then to process element 306 where the program gets the last upgrade date of storage device 50, i.e. of the pen drive. The program proceeds to decision element 308 where the program automatically calculates the difference between the two dates and determines based on some previously inputted preference whether the application software loaded onto pen drive 50 needs to be updated. Specifically the program determines based on the elapsed time if a update download should be made. If it is not in the target period, then the program branches to decision element 310 where the program asks if computer 12 is connected to a global communication system such as the Internet. If it is connected to the Internet, the program branches to process element 312 in which the program downloads the new advertising banners and also any other software or data to be stored on pen drive 50. From there, the program proceeds to process element 314 where the program selectively stores the new banner on either hard disk 18 or on pen drive 50, depending upon how the installer has installed the software. Next the program proceeds to process elements 316 and 318 where the software sets up a banner window on monitor 32 and sets up a window to display a file to be selected. In process element 320 the actual selection is randomly made by the software of what banner is to be displayed. Alternatively, the banners could have identification components which would permit the software to determine when and for how long the banner is to be displayed. The order of display could also be determined by the operator. From process element 320, the program terminates in terminal 322.

If in decision element 310 it was determined that there was no current Internet connection, then in process element 324 an appropriate message is displayed on the current user monitor 32.

If in decision element 308 it is determined that no update should be done at this time, then the program exits at process element 326. The present invention also contemplates pen drives 50 having logos and trademarks of the sponsoring company affixed to the outside so that the commercial message of the medical company is seen by the user.

The present invention has now been described with respect to selected embodiments thereof. However, other embodiments would be obvious to those skilled In the art. Further, it will be appreciated by those skilled in the art that many changes may be made to these embodiments without departing from the principles and the spirit of the invention.

1. A business method for providing promotional information to a patient about a medical company and/or the medical products it markets, said method comprising:
accessing a portable memory device on which is stored in files medical information and patient records of a particular patient with a computer system and retrieving at least one file;
linking a message containing promotional information from a medical company with said retrieved file; and
outputting said retrieved file and linked message so that both are displayed together in a human readable form.

2. A business method as claimed in claim 1 and further including the step of obtaining said memory device from a patient in whose custody said memory device has been kept.

3. A business method as claimed in claim 2 wherein said medical information and record has been stored as an executable file.

4. A business method as claimed in claim 3 wherein said memory device is an active memory device.

5. A business method as claimed in claim 4 wherein said memory device is a pen drive and said computer has a universal port to which said pen drive can be connected; and further including the step of connecting said pen drive to said universal port before said accessing step.

6. A business method as claimed in claim 5 wherein said universal port is an USB port.

7. A business method as claimed in claim 1 wherein said medical information and record has been stored as an executable file.

8. A business method as claimed in claim 7 wherein said providing step provides said output on a video monitor.

9. A business method as claimed in claim 8 and further comprising creating a file window for said file and creating a message window for said message;
said providing step provides said file to the monitor to display in said file window; and
said integrating step provides said message to the monitor to display in said message window.

10. A business method as claimed in claim 7 wherein said providing step provides said output to printer and includes printing said file and message.

11. A business method as claimed in claim 1 wherein said integrating step is performed before said providing step and comprises creating a new combined file, and said providing step includes providing said combined file.

12. The business method as claimed in claim 1 and further including before said accessing step, providing a password to said computer system.

13. The business method as claimed in claim 12 wherein said password is the patient's password.

14. The business method claimed in claim 1 and further comprising updating said promotional information from a website accessible from a global communication system.

15. The business method claimed in claim 14 and further comprising storing promotional information about the medical company on said storage device; and
updating said promotional information on said storage device from a website accessible from a global communication system.

16. An advertising system comprising
a computer system comprising
a computer,
a data memory connected to and accessible by said computer and storing data, and application computer programs,
an operating system for said computer that is capable of directing data input and data output,
an output device that produces a human readable output,
a universal output port, and
a monitor;
a portable active storage device that can be physically plugged into said output port, and that stores medical data in self extracting files that can be retrieved by said computer using said operating system simply by addressing a representation of said file;
an advertising message stored in computer addressable memory; and
an application computer program that integrates said advertising data with said medical data in said human readable output.

17. The advertising system as claimed in claim 16, and further comprising a scanner connectable to said computer that scans documents and provides a scanned document representation to said computer; and
an application computer program that can receive said scanned document representation from said scanner and can store said scanned document representation as an executable file.

18. The advertising system as claimed in claim 17 wherein said computer system further comprises a printer connected to said computer and said output is a printed document that has both medical data and an advertisement message.

19. The advertising system as claimed in claim 16 wherein said computer system further comprises a monitor connected to said computer and said output is a viewable document viewable on said monitor and containing both said medical data and an advertisement message.

20. The advertising system as claimed in claim 16 wherein said portable active storage device is a pen drive that can be plugged into said universal output port.

21. The advertising system as claimed in claim 20 wherein said pen drive comprises a housing having an outer surface; and
said system further comprising advertising indicia on said pen drive housing outer surface.

22. The advertising system as claimed in claim 21 wherein said advertising indicia comprises a logo of a medical company.

23. A business method for providing promotional information about a medical company and/or the medical products it markets, said method comprising:
receiving a portable memory device from a patient, said memory device containing a plurality of self-executing files in which are stored medical information about the patient, and said memory device being attachable to a universal port of a computer system;
attaching said portable memory device to a universal port of a particular computer system being used by a health care system;
receiving a password associated with said patient and said memory device;
entering said password into said computer system so that access to said files stored on said medical device can be obtained;
accessing said self-executing files stored on said medical device with said computer system;
selecting one or more files such that each file selected is automatically opened;
displaying said opened file; and
also displaying along with said opened file promotional information about the medical company and/or the medical products the medical company markets.

24. The business method claimed in claim 22 wherein said files and said promotional information are displayed together on a monitor connected to said computer system.

25. The business method claimed in claim 23 wherein said files and said promotional information are displayed together on a printout from a printer connected to said computer system.

26. The business method claimed in claim 22 wherein an application program for displaying together an opened file that has been stored on said medical device and said promotional information is also stored on said medical device.

27. A business method for providing promotional information to a patient about a medical company and/or the medical products it markets, said method comprising:
Storing medical information and patient records of only a single person in a plurality of files in a portable memory device;
accessing said portable memory device with a computer system and retrieving at least one file;
providing an output of said file in a human readable form; and
integrating a message containing the promotional information with said file output so that both are displayed together.

28. A business method as claimed in claim 27 wherein said storing step stores said medical information and record in each file as an executable file.

29. A business method for making available promotional information about a medical company and/or medical products it markets, said method comprising:
scanning a document containing medical information about a certain patient;
attaching an active portable memory device dedicated to only said certain patient to a universal port of a computer system on which said medical device a message containing identifying or promotional information about said medical company has been previously stored, said message having been stored such that said message can be retrieved whenever a file containing medical information about said patient is retrieved; and
storing said scanned document in an executable file on said memory device.

30. The business method as claimed in claim 29 and further comprising:
accessing said portable memory device with a computer system and retrieving at least one file;
linking said message containing promotional information from a medical company with said retrieved file; and
outputting said retrieved file and linked message so that both are displayed together in a human readable form.

31. The business method as claimed in claim 29 and further including before said storing step, providing a password to said computer system.

32. The business method claimed in claim 29 and further including storing an application program on said medical device, said application program for displaying together an opened file that has been stored on said medical device and said promotional information is also stored on said medical device.

33. The business method claimed in claim 29 and further comprising updating said promotional information on said storage device from a website accessible from a global communication system.
